(19) United States
(12) Patent Application Publication
(10) Pub. No.: US 2025/0216002 A1
(43) Pub. Date: Jul. 3, 2025

(54) VALVE WITH DUAL BALL VALVES

(71) Applicant: Kres(Suzhou) Power Systems Technology Co., Ltd, Suzhou (CN)

(72) Inventor: Jiaxin Wan, Jingdezhen (CN)

(21) Appl. No.: 19/087,463

(22) Filed: Mar. 22, 2025

(30) Foreign Application Priority Data
Nov. 25, 2024 (CN) 202411691237.9

(51) Int. Cl. F16K 35/02; F16K 5/06

(52) U.S. Cl. CPC F16K 35/025; F16K 5/0647

(57) ABSTRACT

The present disclosure discloses a valve with dual ball valves, including two ball valves arranged side by side and clamped with each other, wherein each ball valve includes a valve body, a valve rod and a handle, the valve bodies include abutting surfaces provided with clamping structures, and the valve rods make the ball valves switch between a through-flow state and a closed state in a process of rotating along its own axes. The ball valves further include first anti-misoperation devices and second anti-misoperation devices. The two anti-misoperation devices provide multiple protections for the ball valves to avoid misoperation on the valve.

### TECHNICAL FIELD

The present disclosure relates to the technical field of valves, in particular to a valve with dual ball valves.

### BACKGROUND OF THE INVENTION

A valve with dual ball valves is used by combining the two ball valves together. When a pipeline connected with one ball valve has faults and needs to be removed or repaired, the other ball valve is closed, and the faulty ball valve and pipeline are removed and repaired, thereby omitting the work of leaking stoppage, and facilitating use. For quick assembly between the two ball valves, the two ball valves are often clamped together. According to an existing clamping connection form, a clamping groove is formed in one end of one ball valve, the clamping groove is formed around a fluid channel in the ball valve, a clamping buckle is arranged at one end of the other ball valve, and the clamping buckle is inserted from an opening of the clamping groove and rotates to complete the clamping connection. After the clamping connection is completed, the two ball valves are rotated to be in an open state.

However, the existing valve with the dual ball valves has a low safety coefficient and lacks an anti-removing device. When the two ball valves are in the open state, separating the two ball valves may cause fluid leakage. In order to solve this problem, in the Chinese patent with an application number CN202211424375.1, three anti-misoperation devices are provided to prevent two ball valves from separating in an open state. However, this type of ball valves requires position cooperation between a limiting seat in a special shape and a handle, which is not highly applicable.

### SUMMARY OF THE INVENTION

To overcome the above disadvantages, the objective of the present disclosure is to provide a valve with dual ball valves, and multiple protections are implemented on the ball valves to avoid misoperation on the valve.

In order to achieve the above objective, the technical solution used in the present disclosure is that a valve with dual ball valves includes two ball valves arranged side by side and clamped with each other, wherein each ball valve includes a valve body, a valve rod and a handle, the valve bodies include abutting surfaces provided with clamping structures, the valve rods make the ball valves switch between a through-flow state and a closed state in a process of rotating along its own axes, and each ball valve further includes:
a first anti-misoperation device, including a rotating member and a sliding member, wherein the rotating members and the valve rods are fixed, clamping grooves are formed in the rotating members, in a rotation process of the rotating members, the clamping grooves can be clamped with the sliding members and push the sliding members to move back and forth in a first direction, and when the ball valve is in the through-flow state, the sliding member extends out of the abutting surface and is inserted into the other ball valve; and
a second anti-misoperation device, configured to lock the handles in the closed state when the two ball valves are separated, wherein the second anti-misoperation devices include first locking mechanisms and first positioning grooves, the first locking mechanisms are arranged on the valve bodies, the first positioning grooves are formed in the handles, and when the ball valves are in the closed state, the first locking mechanisms can be clamped onto the first positioning grooves.

The present disclosure has the beneficial effects that:
the two anti-misoperation devices are both linked to the handles. Through the two anti-misoperation devices, using safety of the ball valves is greatly improved, and it is ensured that the ball valves can only be separated when the ball valves are in the closed state, thereby avoiding fluid leakage.

The rotating members of the first anti-misoperation devices can be clamped with sliding members through the clamping grooves in the rotation process to push the sliding members to slide, thereby ensuring that the sliding members are driven to slide in opening and closing processes of the ball valves. The sliding members can extend out of the valve bodies and be inserted into the other ball valve to limit the relative rotation between the two ball valves and avoid liquid leakage caused by the separation of the two ball valves.

The second anti-misoperation devices ensure that the handles can be rotated freely only when the two ball valves are in a clamped state. When two ball valves are separated, that is, one end of a single ball valve is a free end, the first anti-misoperation devices limit the handles to be in a state where the ball valve is closed, thereby reducing misoperation on the ball valves when the ball valves are not properly connected.

Further, the rotating members include first portions, side walls of the first portions are arc surfaces coaxial with the valve rods, second portion protruding out of the side walls of the first portions are connected to the first portions, and the clamping grooves formed by sinking inwards are formed in butt-joint positions of the first portions and the second portions; and the sliding members are slidably connected with the valve bodies and located on one sides of the first portions, the sliding members include clamping portions, the clamping portions include first rod bodies as well as first bosses and second bosses which are arranged in a circumferential direction of the first rod bodies, and in the rotation process of the rotating members, the clamping grooves can be clamped with the first bosses and drive the sliding members to move back and forth in the first direction to extend out of or retract into the valve bodies.

In the rotation process of the rotating members, the sliding members can be pushed by the clamping grooves and the first bosses to slide. At the same time, when the clamping grooves are separated from the first bosses, the positions of the sliding members can be limited by the first bosses and the second bosses. In this way, it is ensured that in the opening and closing processes of the ball valves, the sliding members are driven to slide. When the ball valves are in the through-flow state, the first portions limit the positions of the first bosses and the second bosses, and the sliding members can extend out of the valve bodies and be insert into the other ball valve to limit the relative rotation between the two ball valves, which avoids liquid leakage caused by the separation of the two ball valves; and when the ball valves are in the closed state, the sliding members are pulled by the clamping grooves to retract into the valve bodies and separated from the other ball valve. At this time, the two ball valves can be separated for maintenance. Arrangement of an anti-misoperation mechanism ensures that the two ball valves can only be separated in the closed state, effectively avoiding misoperation and liquid leakage.

Further, the clamping grooves are triangular, the clamping grooves include first inclined surfaces and second inclined surfaces, the first bosses include third inclined surfaces and fourth inclined surfaces, and the third inclined surfaces and the fourth inclined surfaces can abut against the first inclined surfaces and the second inclined surfaces respectively.

The cooperation of the two inclined surfaces make the clamping grooves push the first bosses in the rotation process, and the sliding members are pushed to slide forward in the first direction through the cooperation of the first inclined surfaces and the third inclined surfaces; and when the rotating members rotate clockwise, the sliding members are pushed to slide in a negative direction of the first direction through the cooperation of the second inclined surfaces and the third inclined surfaces.

Further, both the first portions and the second portions are fan rings coaxial with the valve rods, and outer radiuses of the second portions are greater than outer radiuses of the first portions. The two fan rings with different outer radiuses form the rotating members, which facilitates the machining of the rotating members at this time.

Further, the first bosses and the second bosses are located at two ends of the first rod bodies, the first rod bodies are tangent to the side walls of the first portions, second rod bodies are arranged on sides of the first bosses away from the first rod bodies, and radiuses of the second rod bodies are smaller than radiuses of the first rod bodies. The first portions utilize its own radian to make a part of the first portions located between the first bosses and the second bosses. At this time, due to a limitation of the first portions, the sliding members cannot continue to slide in the first direction. Third rod bodies give way to the rotation of the second portions.

Further, the first locking mechanisms include first positioning beads, first positioning pins, and first reset members, the first positioning beads can move back and forth along the valve bodies in a second direction, one ends of the first positioning pins extend out of the abutting surfaces, and the first positioning pins can move back and forth along the valve bodies in the first direction.

When the two ball valves are clamped, the first positioning pins can approach the first reset members under pushing of the other ball valve, and at this time, the first positioning pins can provide a receding space for falling of the first positioning beads; and when the ball valves are separated, the first positioning pins are away from the first reset members under pushing of the first reset members, and the first positioning pins can push the first positioning beads to move upwards and embed a part of the first positioning beads in the first positioning grooves.

Further, first sliding grooves for allowing the first positioning pins to slide and second sliding grooves for allowing the first positioning beads to slide are formed in the valve bodies, the first sliding grooves and the second sliding grooves are formed perpendicular to each other and communicate with each other, and depths of the second sliding grooves are smaller than diameters of the first positioning beads. The depths of the second sliding grooves ensure that when there is no first receding space for communicating with the second sliding grooves, the first positioning beads inevitably have a part protruding out of the second sliding grooves, that is, protruding out of the valve bodies.

The first positioning pins include first sliding portions that match the first sliding grooves, middles of the first sliding portions are sunken towards inner sides in a circumferential direction to form first grooves, and when the first grooves move to be under the second sliding grooves, the first grooves communicate with the second sliding grooves and form a first receding space for allowing the first positioning beads to be completely embedded.

Further, two side surfaces of the first grooves are both inclined surfaces, and openings of the first grooves are of a flaring structure. Utilizing the inclined surfaces of a flared opening facilitates rolling of the first positioning beads and separation of the two.

Further, the ball valves further include third anti-misoperation devices, the third anti-misoperation devices are configured to lock the handles in the through-flow state and the closed state, the third anti-misoperation devices include second locking mechanisms and second positioning grooves, the second locking mechanisms are arranged on the handles and move synchronously with the handles, two second positioning grooves are formed and correspond to the through-flow state and the closed state of the ball valves respectively, and the locking mechanisms can be clamped into the second positioning grooves to limit positions of the handles.

The third anti-misoperation devices move synchronously with the handles and are arranged on the handles without being lost. Moreover, unlocking can be completed only by pushing with external force, thereby avoiding misoperation on the ball valves caused by a false touch on the handles.

Further, the second locking mechanisms include second positioning beads, second positioning pins, and second reset members, the second positioning beads can move back and forth along the handles in the second direction, the second positioning pins can move along the handles in a horizontal direction and reset under pushing of the second reset members, the second positioning pins approach the second reset members under pushing of the external force, at this time, the second positioning pins can provide a second receding space for upward movement of the second positioning beads, and when the second positioning pins are away from the second reset members under driving of the second reset members, the second positioning pins can push the second positioning beads to move downwards and limit a part of the second positioning beads in the second positioning grooves.

When the handles are rotated, the second positioning pins must be pushed through the external force, so as to overcome thrust provided by the second reset members, and make the second positioning pins to move to a position where the second receding space is provided for the upward movement of the second positioning beads. At this time, the handles are pushed again, and the second positioning grooves can be utilized to move the second positioning beads upwards to slide out of the second positioning grooves, thus unlocking the handles. When the second positioning beads reach the second positioning grooves, the second positioning pins are released by the external force, the second positioning pins are reset under driving of the second reset members, at this time, the second positioning beads move downwards under gravity and pushing of the second positioning pins and are partially clamped into the second positioning grooves, and the second positioning pins return to an initial position and limit the upward movement of the second positioning beads, thus locking the handles.

### BRIEF DESCRIPTION OF DRAWINGS

FIG. 1 is a schematic diagram of a stereo structure of a ball valve in an embodiment of the present disclosure.

FIG. 2 is a side view of a ball valve in an embodiment of the present disclosure.

FIG. 3 is a sectional view taken along a line A-A of FIG. 2 when a ball valve in a through-flow state.

FIG. 4 is a sectional view taken along a line A-A of FIG. 2 when a ball valve in a closed state.

FIG. 5 is a schematic structural diagram of a rotating member in an embodiment of the present disclosure.

FIG. 6 is a schematic diagram of a stereo structure of a sliding member in an embodiment of the present disclosure.

FIG. 7 is a sectional view taken along a line B-B in FIG. 2.

FIG. 8 is a sectional view of a third anti-misoperation device in an embodiment of the present disclosure.

In the figures:
1. Valve body;
11. Sliding channel; 12. Positioning hole; 13. Abutting surface; 141. First sliding groove; 142. Second sliding groove; 151. Third sliding groove; 152. Fourth sliding groove;
2. Valve rod;
3. Handle;
4. First anti-misoperation device;
41. Rotating member; 411. First portion; 412. Second portion; 413. Clamping groove; 4131. First inclined surface; 4132. Second inclined surface;
42. Sliding member; 421. First rod body; 422. First boss; 4221. Third inclined surface; 4222, Fourth inclined surface; 423. Second boss; 424. Second rod body; 425. Third rod body;
5. Second anti-misoperation device;
51. First positioning bead; 52. First positioning pin; 521. First groove; 53. First reset member; 54. First positioning groove;
6. Third anti-misoperation device;
61. Second positioning bead; 62. Second positioning pin; 621. Second groove; 63. Second reset member; and 64. Second positioning groove.

### DETAILED DESCRIPTION OF THE INVENTION

Preferred embodiments of the present disclosure are described in detail below in combination with accompanying drawings, so that advantages and features of the present disclosure can be more easily understood by those skilled in the art, and a protection scope of the present disclosure can be more clearly defined.

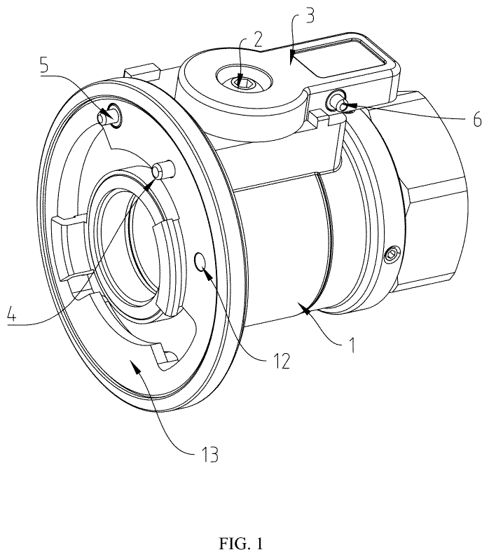

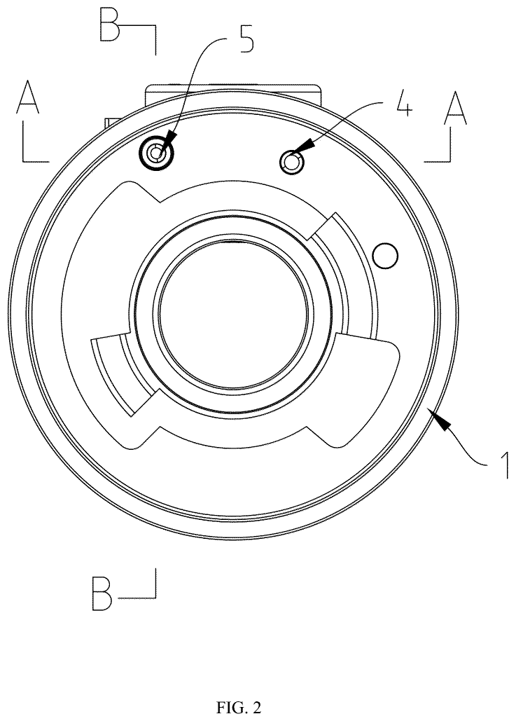

As shown in FIG. 1 and FIG. 2, a valve with dual ball valves of the present disclosure includes two ball valves arranged side by side and clamped with each other. Each ball valve includes a valve body 1, a valve rod 2, and a handle 3. The valve bodies 1 include abutting surfaces 13, the abutting surfaces 13 are provided with clamping structures, and the clamping structures of two ball bodies are mutually cooperative to achieve clamping of the two ball valves. After the abutting surfaces 13 of the two ball valves are in butt joint, one ball valve is rotated to achieve clamping of the two clamping structures.

The valve rods 2 and the handle 3 are fixedly connected, the handles 3 are located on outer sides of the valve bodies 1, and the valve rods 2 are arranged in the valve bodies 1 in a penetrating mode and are fixedly connected with one ball body. When the handles 3 drive the ball body to rotate through the valve rods 2, the ball valves switch between a through-flow state and a closed state, and a rotation angle of the handles 3 is 90°.

The ball valves further include first anti-misoperation devices 4 and second anti-misoperation devices 5. The first anti-misoperation devices 4 are configured to insert the two ball valves when the ball valves are in the through-flow state, so as to avoid separation caused by relative rotation of the two ball valves at this time. The second anti-misoperation devices 5 enable the handles 3 to be rotated freely only when the two ball valves are clamped, and the ball valve is locked in the closed state when separating from the other ball valve. The two anti-misoperation devices are both linked to the handles 3. Through the two anti-misoperation devices, using safety of the ball valves is greatly improved, and it is ensured that the ball valves can only be separated when the ball valves are in the closed state, thereby avoiding fluid leakage.

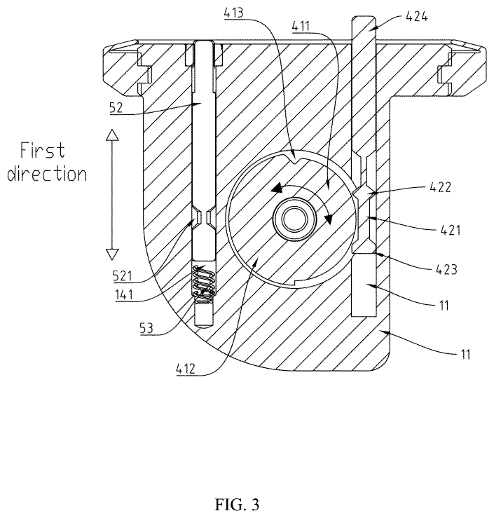

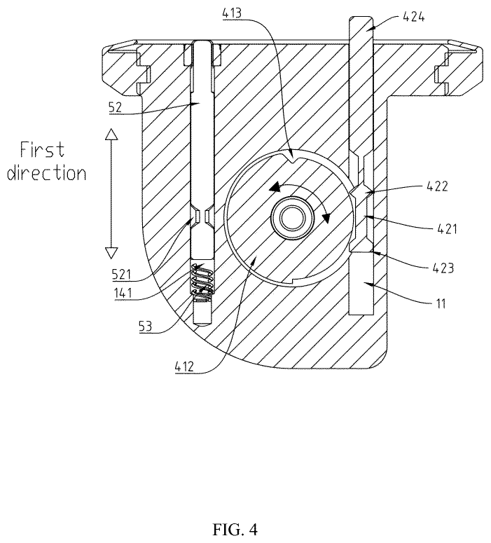

As shown in FIG. 3 and FIG. 4, the first anti-misoperation devices 4 include rotating members 41 and sliding members 42, the rotating members 41 and the valve rods 2 are fixed, clamping grooves 413 are formed in the rotating members 41, in a rotation process of the rotating members 41, the clamping grooves 413 can be clamped with the sliding members 42 and push the sliding members 42 to move back and forth in a first direction (a moving direction of fluid), and when the ball valve is in the through-flow state, the sliding member 42 extends out of the abutting surface 13 and is inserted into the other ball valve.

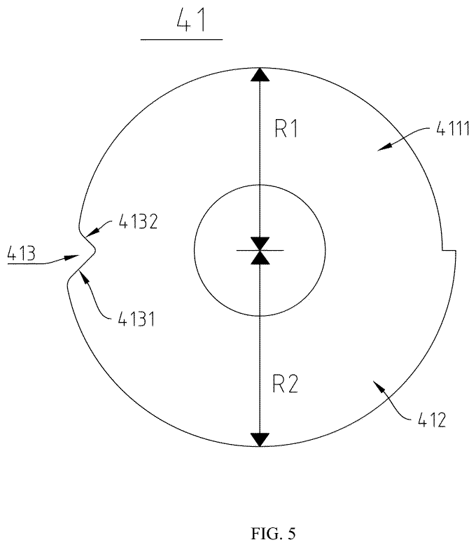

As shown in FIG. 5, the rotating members 41 are fixed to the valve rods 2. The rotating members 41 include first portions 411, side walls of the first portions 411 are arc surfaces coaxial with the valve rods 2, second portions 412 protruding out of the side walls of the first portions are connected to the first portions 411, and the clamping grooves 413 sunken inwards are formed in butt-joint positions of the first portions 411 and the second portions 412.

The sliding members 42 are slidably connected with the valve bodies 1 and located on one sides of the first portions 411, the sliding members 42 include clamping portions, and the clamping portions include first rod bodies 421 as well as first bosses 422 and second bosses 423 which extend towards an outer side in a circumferential direction of the first rod bodies 421. In the rotation process of the rotating members 41, the clamping grooves 413 can be clamped with the first bosses 422 so as to drive the sliding members 42 to move back and forth in the first direction. When the ball valves are in the through-flow state, the clamping grooves 413 disengage from the first bosses 422, a part of the sliding members 42 extends out of the abutting surfaces of the valve bodies 1, and parts of the first bosses 422 and the second bosses 423 abut against the side walls of the first portions 411. At this time, a limiting groove is formed between the first bosses 422 and the second bosses 423, and a part of the first portions 411 is located in this limiting groove to limit the positions of the sliding members 42 and prevent the sliding members 42 from moving. When the ball valves are in the closed state, the clamping grooves 413 are clamped with the first bosses 422 and push the sliding members 42 to retract into the valve bodies 1, and at this time, the two ball valves can rotate and separate.

As shown in FIG. 3, when the ball valves are in the through-flow state, the sliding members 42 can extend out of the valve bodies 1 to be inserted into the other ball valve to limit the relative rotation between the two ball valves, thereby avoiding liquid leakage caused by the separation of the two ball valves. As shown in FIG. 4, when the ball valves are in the closed state, the sliding members 42 are pulled by the clamping grooves 413 to retract into the valve bodies, and the ball valve can only be separated from the other ball valve at this time. The arrangement of the first anti-misoperation devices 4 ensures that the two ball valves can only be rotated and separated in the closed state, which effectively avoids misoperation and liquid leakage.

In one embodiment, as shown in FIG. 5, both the first portions 411 and the second portions 412 are fan rings coaxial with the valve rods 2, and outer radiuses R2 of the second portions 412 are greater than outer radiuses R1 of the first portions 411. Angles of both the first portions 411 and the second portions 412 are 90°, which means that the two fan rings are spliced together in a horizontal plane to form the rotating members 41. Certainly, the first portions 411 may also be one circular ring, and the second portions 412 are protruding blocks protruding along the side walls of the first portions 411. At this time, the rotating members 41 can also push the sliding members 42 through the clamping grooves 413, and limit the positions of the sliding members 42 through the side walls of arcs of the first portions 411.

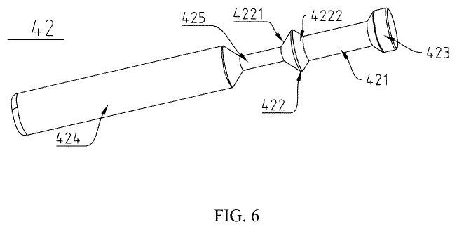

As shown in FIG. 5, the clamping grooves 413 are triangular and are formed towards inner sides (a direction of the valve rods 2) along a boundary between the side walls of the first portions 411 and the second portions 412. The clamping grooves 413 include first inclined surfaces 4131 and second inclined surfaces 4132, the first inclined surfaces 4131 are connected to side walls of the second portions 412, and the second inclined surfaces 4132 are connected to the side walls of the first portions 411. As shown in FIG. 6, the first bosses 422 include third inclined surfaces 4221 and fourth inclined surfaces 4222, and the third inclined surfaces 4221 and the fourth inclined surfaces 4222 can abut against the first inclined surfaces 4131 and the second inclined surfaces 4132 respectively. When inserting grooves and the first bosses 422 are clamped, inclination directions of the first inclined surfaces 4131 and the third inclined surfaces 4221 are the same, and inclination directions of the third inclined surfaces 4221 and the fourth inclined surfaces 4222 are the same.

Rotation directions of the rotating members 41 are shown by an arrow in FIG. 4. When the rotating members 41 rotate clockwise, the sliding members 42 are pushed to slide downwards in the first direction by the cooperation of the first inclined surfaces 4131 and the third inclined surfaces 4221; and when the rotating members 41 rotate anticlockwise, the sliding members 42 arc pushed to slide downwards in the first direction by the cooperation of the second inclined surfaces 4132 and the third inclined surfaces 4221.

As shown in FIG. 3 and FIG. 4, sliding channels 11 are formed in the valve bodies 1, and the sliding members 42 move back and forth along axes of the sliding members 11 in the sliding channels 11. The sliding channels 11 play a role in guiding slide of the sliding members 42, and allow the sliding members 42 to only slide along the sliding channels 11.

As shown in FIG. 6, the sliding members 42 further include inserting portions, the inserting portions are connected to the clamping portions, the inserting portions include second rod bodies 424 coaxial with the first rod bodies 421, and the second rod bodies 424 match the sliding channels 11 and can extend out of the valve bodies 1 to be inserted into the other ball valves. Radiuses of the second rod bodies 424 are the same as radiuses of the sliding channels 11 or slightly smaller than the radiuses of the sliding channels 11, so that the sliding members 42 cannot deviate when sliding in the sliding channels 11. Ends of the second rod bodies 424 can extend out of the sliding channels 11. In a sliding process of the sliding members 42, the second rod bodies 424 are always partially located in the sliding channels 11 to play a guiding role in the sliding channels 11.

The first bosses 422 and the second bosses 423 are located at two ends of the first rod bodies 421, and the first rod bodies 421 are tangent to the side walls of the first portions 411. At this time, a part of the first rod bodies 421 can abut against the part of the side walls of the first portions 411. The first portions 411 make a part of the first portions 411 located between the first bosses 422 and the second bosses 423 by utilizing its own radian. At this time, due to limitation of the first portions 411, the sliding members 42 cannot continue to slide in the first direction.

The clamping portions further include third rod bodies 425 coaxial with the first rod bodies 421, the third rod bodies 425 are located on one sides of the first bosses 422 away from the first rod bodies 421, and radiuses of the third rod bodies 425 are smaller than radiuses of the first rod bodies 421. A receding groove is formed between the third rod bodies 425 and side walls of guiding channels to give a way for the second portions 412. When the rotating members 41 rotate to a position where the clamping grooves 413 and the first bosses 422 are clamped, the second portions 412 move to a position corresponding to the third rod bodies 425. Because outer radiuses of the second portions 412 are greater than outer radiuses of the first portions 411, the radiuses of the third rod bodies 425 are reduced to give a way for the second portions 412. At the same time, the third rod bodies 425 connect the first bosses 422 and the second rod bodies 424 as a whole. A difference value between the radiuses of the third rod bodies 425 and the radiuses of the first rod bodies 421 is greater than a difference value between the outer radiuses of the first portions 411 and the outer radiuses of the second portions 412, thereby providing a sufficient space for the movement of the second portions 412.

A positioning hole 12 for allowing the sliding member 42 of the other ball valve to be inserted is formed in the valve body 1 along the abutting surface 13 towards the inner side. When one ball valve is in the through-flow state, the sliding member 42 extends out of the valve body 1 and is inserted into the positioning hole 12 of the other ball valve to avoid the misoperation between the two ball valves. Only when the ball valves are in the closed state, the sliding members 42 can slide out of the positioning holes 12 and retract into the valve bodies 1, and at this time, the two ball valves can rotate and separate from each other.

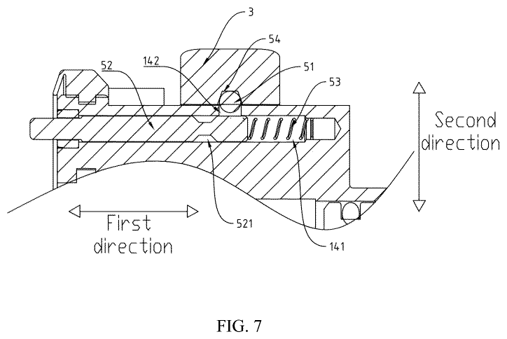

The second anti-misoperation devices 5 can ensure that the handles 3 can be rotated to the through-flow state of the ball valves only when the two ball valves are in a clamped state. That is, when the two ball valves are not connected and separated, the handles 3 can only be in a position wherein the ball valves are in the closed state, and the ball valves cannot be rotated to be opened. At this time, the second anti-misoperation devices 5 lock the ball valves in the closed state. As shown in FIG. 2 and FIG. 7, the second anti-misoperation devices 5 include first locking mechanisms and first positioning grooves 54. The first locking mechanisms are arranged on the valve bodies 1, the first positioning grooves 54 are formed in the handles 3, and when the ball valves are in the closed state, the first locking mechanisms can be clamped into the first positioning grooves 54 and limit the handles 3 to this position.

The first locking mechanisms include first positioning beads 51, first positioning pins 52, and first reset members 53, the first positioning beads 51 can move back and forth along the valve bodies 1 in a second direction (a vertical direction perpendicular to the first direction), the positioning pins are slidably connected to the valve bodies 1, one ends of the positioning pins can extend out of the valve bodies 1, and the first positioning pins 52 can move back and forth along the valve bodies 1 in the first direction. When the two ball valves are clamped, the first positioning pins 52 can move towards the first reset members 53 under pushing of the abutting surface 13 of the other ball valve, at this time, the first positioning pins 52 can provide the first receding space for the first positioning beads 51, and the first positioning beads 51 move downwards under the action of gravity to be completely embedded into the valve bodies 1. At this time, the first positioning beads 51 have no limiting effect on the handles 3, and the handles 3 may rotate.

When the two ball valves are separated, the two ball valves can only be separated when being in the closed state due to the limitation of the first anti-misoperation devices 4. At this time, the first positioning pins 52 are away from the first reset members 53 under driving of the first reset members 53 and reset, and the first positioning pins 52 can push the first positioning beads 51 to move upwards and limit the part of the first positioning beads 51 in the first positioning grooves 54, so that the handles 3 are kept in the closed state of the ball valves. After the two ball valves are clamped, the abutting surface 13 of one ball valve pushes the first positioning pin 52 of the other ball valve to move towards the first reset members 53, and the first positioning pin 52 moves to a position where the first receding space is provided for upward movement of the first positioning beads 51. At this time, the first positioning beads 51 are completely embedded in valve seats and do not limit the handles 3, and the valve with the dual ball valves is in a use state, and the handles 3 can be freely rotated.

As shown in FIG. 7, first sliding grooves 141 and second sliding grooves 142 are formed in the valve bodies 1, the first sliding grooves 141 and the second sliding grooves 142 are formed perpendicular to each other and communicate with each other, and the first sliding grooves 141 extend in the first direction. One ends of the second sliding grooves 142 are located in middles of the first sliding grooves 141, and the first sliding grooves 141 and the second sliding grooves 142 form a T-shaped structure. The first positioning pins 52 slide in the first sliding grooves 141, and the first positioning beads 51 slide in the second sliding grooves 142. Widths of the second sliding grooves 142 are greater than diameters of the first positioning beads 51, so that the first positioning beads 51 can slide in the second sliding grooves 142. Moreover, depths of the second sliding grooves 142 are smaller than the diameters of the first positioning beads 51, and in an initial state, the first positioning beads 51 partially protrude out of the second sliding grooves 142.

The first positioning pins 52 include first sliding portions that match the first sliding grooves 141, middles of the first sliding portions are sunken inwards in a circumferential direction to form first grooves 521, and when the first grooves 521 move to be under the second sliding grooves 142, the first grooves 521 and the second sliding grooves 142 are communicate and form a first receding space for allowing the first positioning beads 51 to be completely embedded. Under pushing of the reset members, ends of the first sliding portions extend out of the abutting surfaces 13.

When other parts of the first sliding portions move to be under the second sliding grooves 142, the other parts of the first sliding portions close connections of the second sliding grooves 142 and the first sliding grooves 141, and the first positioning beads 51 can only be in the second sliding grooves 142. At this time, due to heights of the second sliding grooves 142 being smaller than the diameters of the first positioning beads 51, a part of the first positioning beads 51 inevitably protrude out of the second sliding grooves 142, that is, protruding out of the valve bodies 1 to be clamped into the first positioning grooves 54. When the first grooves 521 move to be under the second sliding grooves 142, the first grooves 521 communicate with the second sliding grooves 142 and form the first receding space with the first sliding grooves 141, which extends the depths of the second sliding grooves 142. A sum of the depths of the second sliding grooves 142 and the first receding space is greater than the diameters of the first positioning beads 51, so as to ensure that the first positioning beads 51 can be fully embedded into the valve bodies 1. At this time, third anti-misoperation devices 6 on the handles 3 are released and the positions of the handles 3 can be adjusted at any time.

In one embodiment, as shown in FIG. 7, side walls of the first grooves 521 are inclined surfaces, that is, openings of the first grooves 521 are of a flaring structure, and when the first positioning pins 52 are reset, the first positioning beads 51 can slide along an inclined surface of the flaring structure of the first grooves 521. The first positioning beads 51 are pushed to roll through cooperation with the inclined surface, thereby reducing hard contact between the first positioning beads 51 and the first positioning pins 52, and prolonging the service life of the first positioning beads 51 and the first positioning pins 52.

The first reset members 53 are springs, the springs are embedded in the first sliding grooves 141, one ends of the springs abut against bottoms of the first sliding grooves 141, and the other ends of the springs abut against ends of the first positioning pins 52. When the first positioning pins 52 retract into the first sliding grooves 141, the springs are in a compressed state.

In one embodiment, the ball valves further include the third anti-misoperation devices 6, and the third anti-misoperation devices 6 are configured to lock the handles 3 in the through-flow state and the closed state. At this time, action force must be applied to the third anti-misoperation devices 6 for unlocking, so as to push the handles 3 to rotate, avoiding the rotation of the handles 3 caused by accidental collision with the handles 3. At this time, the three anti-misoperation devices provide triple protection for the valve, improving the safety of the valve.

The third anti-misoperation devices include second locking mechanisms arranged on the handles 3 of the ball valves, and the second locking mechanisms can move synchronously with the handles 3. The valve bodies 1 are provided with second positioning grooves 64 formed corresponding to the second locking mechanisms, and two second positioning grooves 64 are provided and are located in a first position and a second positions respectively. When the second locking mechanisms move to the first position or above the second position, the second locking mechanisms can be clamped into the second positioning grooves 64 in the corresponding positions, and at this time, the ball valves are in the through-flow state or the closed state.

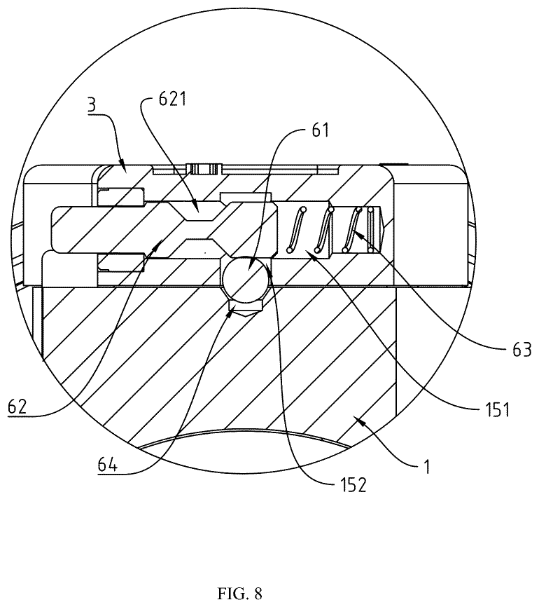

As shown in FIG. 8, the second locking mechanisms include second positioning pins 62, second reset members 63 and second positioning beads 61, and the second positioning beads 61 can move back and forth along the handles 3 in the vertical direction. The second positioning pins 62 are slidably connected to the handles 3 and can move in a horizontal plane under pushing of external force and the reset members. The second positioning pins 62 can approach the second reset members 63 under pushing of the external force, and at this time, the second positioning pins 62 can provide a second receding space for upward movement of the second positioning beads 61. When the second positioning pins 62 are away from the second reset members 63 under driving of the second reset members 63, the second positioning pins 62 can push the second positioning beads 61 to move downwards and limit a part of the second positioning beads 61 in the second positioning grooves 64.

In one embodiment, depths of the second positioning grooves 64 are smaller than radiuses of the second positioning beads 61, and only a small part of the second positioning beads 61 can be located in the second positioning grooves 64, that is, the part of the second positioning beads 61 embedded in the second positioning grooves 64 is less than half of the second positioning beads 61. Such depths of the second positioning grooves 64 can ensure that the second positioning beads 61 are pushed out of the second positioning grooves 64 in the rotation process of the handles 3.

Third sliding grooves 151 and fourth sliding grooves 152 are formed in the handles 3. The third sliding grooves 151 and the fourth sliding grooves 152 are perpendicular to each other and communicate with each other. One ends of the fourth sliding grooves 152 are located in middles of the third sliding grooves 151, the third sliding grooves 151 are used for sliding of the second positioning pins 62, and the fourth sliding grooves 152 are used for sliding of the second positioning beads 61. The second positioning pins 62 and the first positioning pins 52 have the same structure, and the second positioning pins 62 include second sliding portions and a second groove 621.

When the second limiting portions move to be over the fourth sliding grooves 152, the second limiting portions close connections of the third sliding grooves 151 and the fourth sliding grooves 152, and the second positioning beads 61 can only be in the fourth sliding grooves 152. At this time, due to heights of the fourth sliding grooves 152 being smaller than the diameters of the second positioning beads 61, a part of the second positioning beads 61 inevitably protrudes out of the fourth sliding grooves 152, that is, protruding out of the handles 3.

When the second groove 621 moves to be over the fourth sliding grooves 152, the second groove 621 communicates with the fourth sliding grooves 152 and defines a second receding space with the first sliding grooves 141. That is, the heights of the fourth sliding grooves 152 are extended, and a sum of the heights of the fourth sliding grooves 152 and the second receding space is greater than the diameters of the second positioning beads 61, so as to ensure that the second positioning beads 61 can be fully embedded into the handles 3. At this time, the handles 3 are rotated through the external force, and the second positioning grooves 64 can push the second positioning beads 61 to move upward and slide out of the second positioning grooves 64, so as to release fixation between the second positioning beads 61 and the second positioning grooves 64, that is, releasing positioning of the handles 3.

Side walls of the second positioning grooves 64 are inclined surfaces, which facilitates rolling of the second positioning beads 61 out of the second positioning grooves 64.

In this embodiment, the handles 3, the valve rods 2, and the rotating members 41 are integrated into one piece.

At the beginning, the two ball valves are in a separated state, and the handles 3 are located at the position in the closed state at this time, the first positioning pins 52 jack the first positioning beads 51 upwards into the first positioning grooves 54, and the handles 3 cannot rotate. The clamping grooves 413 in the rotating members 41 are clamped with the sliding members 42 and pull the sliding members 42 to retract into the valve bodies 1. After the two ball valves are clamped, the first positioning pins 52 always extrude the first reset members 53 under extrusion of the corresponding valve bodies 1. At this time, the first grooves 521 remain in a state of being communicating with second groove bodies, and the first positioning beads 51 move downwards to release the limiting on the handles 3. The second positioning pins 62 are pressed, then the handles 3 are rotated to make the second positioning beads 61 slide out of one second positioning groove 64 (the ball valves are in the closed state) until the second positioning beads 61 move into another second positioning groove 64 (the ball valves are in an open state), the second positioning pins 62 are released, and the second positioning beads 61 are embedded into the second positioning grooves 64 at this position under the pushing of the second positioning pins 62 and remain stationary. At this time, in a process that the handles 3 drive the rotating members 41 to rotate, the clamping grooves 413 push the sliding members 42 to extend out of the valve bodies 1 and be inserted into vacant holes, and limit the sliding members 42 in this position to be unable to move, and the two ball valves cannot rotate with each other anymore.

The above implementations are only intended to illustrate the technical concept and characteristics of the present disclosure, are intended to make those familiar with the technology understand the content of the present disclosure and implement it, and cannot limit the scope of protection of the present disclosure hereby. Any equivalent changes or modifications made according to the spirit of the present disclosure should be covered in the scope of protection of the present disclosure.

What is claimed is:

1. A valve with dual ball valves, comprising two ball valves arranged side by side and clamped with each other, wherein each ball valve comprises a valve body, a valve rod and a handle, the valve bodies comprise abutting surfaces provided with clamping structures, the valve rods make the ball valves switch between a through-flow state and a closed state in a process of rotating along axes of the valve rods, and each ball valve further comprises:
a first anti-misoperation device, comprising a rotating member and a sliding member, wherein the rotating members and the valve rods are fixed, clamping grooves are formed in the rotating members, in a rotation process of the rotating members, the clamping grooves are able to be clamped with the sliding members and push g the sliding members to move back and forth in a first direction, and when the ball valve is in the through-flow state, the sliding member extends out of the abutting surface and is inserted into the other ball valve; and
a second anti-misoperation device, configured to lock the handles in the closed state when the two ball valves are separated, wherein the second anti-misoperation devices comprise first locking mechanisms and first positioning grooves, the first locking mechanisms are arranged on the valve bodies, the first positioning grooves are formed in the handles, and when the ball valves are in the closed state, the first locking mechanisms are able to be inserted into the first positioning grooves.

2. The valve with the dual ball valves according to claim 1, wherein the rotating members comprise first portions, side walls of the first portions are arc surfaces coaxial with the valve rods, second portions protruding out of the side walls of the first portions are connected to the first portions, and the clamping grooves formed by sinking inwards are formed in butt-joint positions of the first portions and the second portions; and the sliding members are slidably connected with the valve bodies and located on one sides of the first portions, the sliding members comprise clamping portions, the clamping portions comprise first rod bodies as well as first bosses and second bosses which extend outwards in a circumferential direction of the first rod bodies, and in the rotation process of the rotating members, the clamping grooves are able to be clamped with the first bosses and drive the sliding members to move back and forth in the first direction to extend out of or retract into the valve bodies.

3. The valve with the dual ball valves according to claim 2, wherein the clamping grooves are triangular, the clamping grooves comprise first inclined surfaces and second inclined surfaces, the first bosses comprise third inclined surfaces and fourth inclined surfaces, and the third inclined surfaces and the fourth inclined surfaces are able to abut against the first inclined surfaces and the second inclined surfaces respectively.

4. The valve with the dual ball valves according to claim 2, wherein both the first portions and the second portions are fan rings coaxial with the valve rods, and outer radiuses of the second portions are greater than outer radiuses of the first portions.

5. The valve with the dual ball valves according to claim 2, wherein the first bosses and the second bosses are located at two ends of the first rod bodies, the first rod bodies are tangent to the side walls of the first portions, second rod bodies are arranged on sides of the first bosses away from the first rod bodies, and radiuses of the second rod bodies are smaller than radiuses of the first rod bodies.

6. The valve with the dual ball valves according to claim 1, wherein the first locking mechanisms comprise first positioning beads, first positioning pins, and first reset members, the first positioning beads are able to move back and forth along the valve bodies in a second direction, and the first positioning pins are able to move back and forth along the valve bodies in the first direction so as to extend out of the abutting surfaces or retract into the valve bodies; and
when the two ball valves are clamped, the first positioning pins are able to approach the first reset members under pushing of the other ball valve, and at this time, the first positioning pins are able to provide a first receding space for falling of the first positioning beads; and when the two ball valves are separated, the first positioning pins are reset under pushing of the first reset members, and the first positioning pins are able to push the first positioning beads to move upwards and embed a part of the first positioning beads in the first positioning grooves.

7. The valve with the dual ball valves according to claim 6, wherein first sliding grooves for allowing the first positioning pins to slide and second sliding grooves for allowing the first positioning beads to slide are formed in the valve bodies, the first sliding grooves and the second sliding grooves are formed perpendicular to each other and communicate with each other, and depths of the second sliding grooves are smaller than diameters of the first positioning beads; and
the first positioning pins comprise first sliding portions that match the first sliding grooves, middles of the first sliding portions are sunken towards inner sides in a circumferential direction to form first grooves, and when the first grooves move to be under the second sliding grooves, the first grooves communicate with the second sliding grooves and form a first receding space for allowing the first positioning beads to be completely embedded.

8. The valve with the dual ball valves according to claim 7, wherein two side surfaces of the first grooves are both inclined surfaces, and openings of the first grooves are of a flaring structure.

9. The valve with the dual ball valves according to claim 1, wherein the ball valves further comprise third anti-misoperation devices, the third anti-misoperation devices are configured to lock the handles in the through-flow state and the closed state, the third anti-misoperation devices comprise second locking mechanisms and second positioning grooves, the second locking mechanisms are arranged on the handles and move synchronously with the handles, two second positioning grooves are formed in the valve bodies and respectively correspond to the through-flow state and the closed state of the ball valves, and the locking mechanisms are able to be clamped into the second positioning grooves to limit positions of the handles.

10. The valve with the dual ball valves according to claim 9, wherein the second locking mechanisms comprise second positioning beads, second positioning pins, and second reset members, the second positioning beads are able to move back and forth along the handles in the second direction, the second positioning pins are able to move along the handles in a horizontal direction and reset under pushing of the second reset members, the second positioning pins are able to approach the second reset members under pushing of external force, at this time, the second positioning pins are able to provide a second receding space for upward movement of the second positioning beads, and when the second positioning pins are away from the second reset members under driving of the second reset members, the second positioning pins are able to push the second positioning beads to move downwards and limit a part of the second positioning beads in the second positioning grooves.
